(19) United States
(12) Patent Application Publication
(10) Pub. No.: US 2014/0101210 A1
(43) Pub. Date: Apr. 10, 2014

(54) IMAGE PROCESSING APPARATUS CAPABLE OF EASILY SETTING FILES THAT CAN BE STORED, METHOD OF CONTROLLING THE SAME, AND STORAGE MEDIUM

(71) Applicant: Canon Kabushiki Kaisha, Tokyo (JP)

(72) Inventor: Satoru NAKAJIMA, Yokohama-shi (JP)

(73) Assignee: Canon Kabushiki Kaisha, Tokyo (JP)

(21) Appl. No.: 14/043,888

(22) Filed: Oct. 2, 2013

(30) Foreign Application Priority Data
Oct. 10, 2012 (JP) 2012-225019

(51) Int. Cl. G06F 17/30

(52) U.S. Cl. CPC G06F 17/30091
USPC 707/821

(57) ABSTRACT

An image processing apparatus capable of easily setting files permitted to be stored and also enables editing of the files which are stored. A HDD is capable of storing files. A document management section manages basic extensions each indicative of a type of a file permitted to be stored in the HDD and associated extensions each indicative of a type of a file associated with a file permitted to be stored in the HDD, in association with each other. The document management section permits a file associated with a file of which a type is indicated by a basic type information item managed by the management unit and which is open to be stored in the HDD.

### BACKGROUND OF THE INVENTION

1. Field of the Invention

The present invention relates to an image processing apparatus, a method of controlling the same, and a storage medium.

2. Description of the Related Art

Conventionally, an image processing apparatus having a function for storing and managing document files has been brought into practical use. This function is called a box function, and enables the image processing apparatus to store data scanned by a scanner function thereof, and store document files created by an application on a personal computer (PC) and received therefrom via a network. Further, it is also possible to view and edit document files stored in a box of the image processing apparatus from the PC connected to the network.

The image processing apparatus is also capable of selecting whether or not to permit document files to be written from the PC into the box. In a case where the writing of document files is not permitted, it is possible to view document files in the box from the PC but impossible to edit them or store new document files in the box from the PC.

Further, it is possible to permit the image processing apparatus to store only document files having specific extensions in the box. In this case, unless a document file desired to be stored has an extension registered in the image processing apparatus, it is impossible to store the document file in the box.

Extensions of document files permitted to be stored are registered in an unchangeable manner in advance, and unless a document file desired to be stored has an extension registered in the image processing apparatus, it is impossible to store the document file. To add an extension so as to permit storage of files having the extension, it is required to modify an associated program.

In such a case, it is inefficient when time required for modifying the program and expandability of the program are taking into consideration. In view of this, there has been proposed a method of enabling conditions of storage of files to be easily changed without modifying the program (see e.g. Japanese Patent Laid-Open Publication No. 2011-61563). Further, there has been proposed a method of setting conditions of storage of files on a storage destination-by-storage destination basis (see e.g. Japanese Patent Laid-Open Publication No. 2006-287869).

According to the method proposed in Japanese Patent Laid-Open Publication No. 2011-61563, specific users such as administrators are permitted to change the conditions of storage of files on a file server-by-file server basis by operation from a console section of the image processing apparatus.

However, in this case, it is necessary to make all possible conditions ready to be applied, beforehand.

That is, assuming that an extension is a condition of storage, it is required to make all extensions of document files which can be created by various document editing applications, ready to be applied, beforehand, so as to enable such a specific user to select from them.

For this reason, if a new application comes to be usable in future which creates a document file with a new extension given thereto, it is required to change the program so as to add the new extension.

Further, a user who configures conditions of storage needs to comprehend what document editing application gives what extension of document files permitted to be stored.

Further, depending on a document editing application, upon opening of a document file associated therewith, a temporary file is created for the backup of edited data. The temporary file is sometimes given a different extension from that of the document file, and the different extension of the temporary file is difficult for the user to comprehend.

Further, similar to the conventional image processing apparatus, in a case where an image processing apparatus has a function for permitting only document files having specific extensions to be stored, unless the extension of a temporary file has been registered, the temporarily file cannot be created.

In the case where the temporary file cannot be created, the document editing application opens the document file only for reading. However, if the image processing apparatus has been configured to permit the document file to be written from a PC, this brings about a problem that although the document file is configured to be editable, the document file is opened only for reading.

To solve this problem without modifying the program, it is required to lift extension-based storage restrictions on temporary files. However, this permits files having the same extension as a temporary file to be intentionally stored even though the files are not temporary files.

Many of these files are not associated with the application, and hence storage of these files is useless, causing wasteful use of an area for storing document files.

According to the method proposed in Japanese Patent Laid-Open Publication No. 2006-287869, although it is possible to limit files to be stored according to a storage destination, it is required to specify conditions on a storage destination-by-storage destination basis. This makes troublesome the operation for setting a common condition to all storage destinations.

### SUMMARY OF THE INVENTION

The present invention provides an image processing apparatus capable of easily setting files permitted to be stored and enables editing of the stored files, a method of controlling the same, and a storage medium.

In a first aspect of the present invention, there is provided an image processing apparatus comprising a storage section configured to be capable of storing files, a management unit configured to manage basic type information items each indicative of a type of a file permitted to be stored in the storage section and associated type information items each indicative of a type of a file associated with a file permitted to be stored in the storage section, in association with each other, and a permission unit configured to permit a file associated with a file of which a type is indicated by a basic type information item managed by the management unit and which is open to be stored in the storage section.

In a second aspect of the present invention, there is provided a method of controlling an image processing apparatus including a storage section configured to be capable of storing files, comprising managing basic type information items each indicative of a type of a file permitted to be stored in the storage section and associated type information items each indicative of a type of a file associated with a file permitted to be stored in the storage section, in association with each other, and permitting a file associated with a file of which a type is indicated by a basic type information item managed by the managing and which is open to be stored in the storage section.

In a third aspect of the present invention, there is provided a non-transitory computer-readable storage medium storing a computer-executable program for causing a computer to execute a method of controlling an image processing apparatus including a storage section configured to be capable of storing files, wherein the method comprises managing basic type information items each indicative of a type of a file permitted to be stored in the storage section and associated type information items each indicative of a type of a file associated with a file permitted to be stored in the storage section, in association with each other, and permitting a file associated with a file of which a type is indicated by a basic type information item managed by the managing and which is open to be stored in the storage section.

According to the present invention, it is possible to provide an image processing apparatus capable of easily setting files permitted to be stored and also enable editing of the stored files, a method of controlling the same, and a storage medium.

Further features of the present invention will become apparent from the following description of exemplary embodiments with reference to the attached drawings.

### BRIEF DESCRIPTION OF THE DRAWINGS

FIG. 1 is a diagram schematically showing the arrangement of a document file management system including an image processing apparatus according to an embodiment of the present invention.

FIG. 2 is a schematic block diagram of the image processing apparatus appearing in FIG. 1.

FIG. 3 is a diagram showing the structure of folders stored in an HDD appearing in FIG. 2.

FIG. 4 is a diagram showing the software configuration of the image processing apparatus appearing in FIG. 1.

FIG. 5 is a flowchart of a list transmission process executed by a CPU appearing in FIG. 2.

FIG. 6 is a flowchart of a document file storage process executed by the CPU appearing in FIG. 2.

FIG. 7 is a diagram showing an example of a permitted extension list stored in a RAM appearing in FIG. 2.

FIG. 8 is a flowchart of a file opening-time process executed by the CPU appearing in FIG. 2.

FIG. 9 is a diagram showing an example of an open state management list stored in the RAM appearing in FIG. 2.

FIG. 10 is a flowchart of a document file creation-time process executed by the CPU appearing in FIG. 2.

### DESCRIPTION OF THE EMBODIMENTS

The present invention will now be described in detail below with reference to the accompanying drawings showing embodiments thereof.

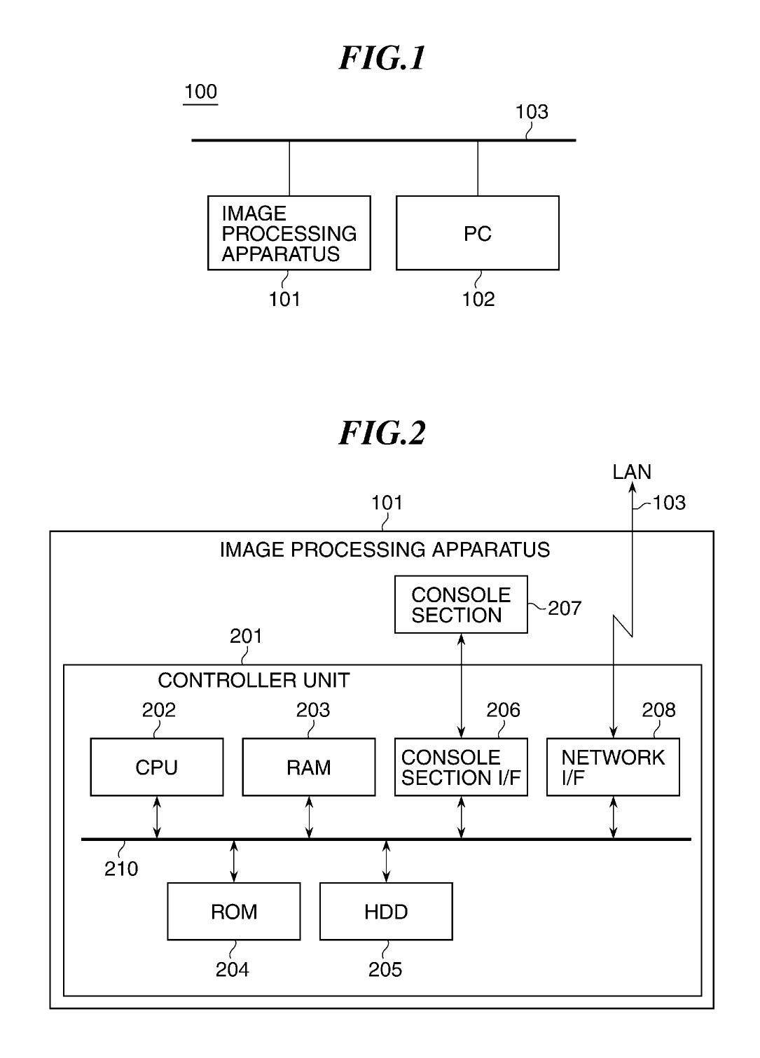

FIG. 1 is a diagram schematically showing the arrangement of a document file management system 100 including an image processing apparatus 101 according to an embodiment of the present invention.

In FIG. 1, the document file management system 100 is configured by connecting the image processing apparatus 101 and a PC (personal computer) 102 to a LAN 103. Note that the document file management system 100 may be configured by connecting a plurality of image processing apparatuses 101 and a plurality of PCs to the LAN 103.

FIG. 2 is a schematic block diagram of the image processing apparatus 101 appearing in FIG. 1.

Referring to FIG. 2, the image processing apparatus 101 comprises a controller unit 201 and a console section 207. Although in the present embodiment, the image processing apparatus 101 is assumed to be a multifunction peripheral having a copy function and a scan function, the image processing apparatus 101 may be an apparatus other than the multifunction peripheral insofar as it has a function of “box”, described hereinafter.

The controller unit 201 comprises a CPU 202, a RAM 203, a ROM 204, a HDD (hard disk drive) 205, a console section interface 206, and a network interface 208, which are connected by a system bus 210.

The CPU 202 controls the overall operation of the image processing apparatus 101. The RAM 203 is a system work memory used by the CPU 202 for operation. The ROM 204 is a boot ROM that stores a boot program of the system.

The HDD 205 corresponds to a storage section and is capable of storing system software, document files, data files for use in managing the document files, and so forth. The function of managing the document files by using the data files is called a box function.

Folders can be created in the HDD 205, and document files, data files, etc. are stored in the folders. The folders will be described hereinafter.

The console section interface 206 interfaces with the console section 207 and outputs to the console section 207 information to be displayed on the console section 207. Further, the console section interface 206 serves to transmit information input by a user from the console section 207 to the CPU 202. The console section 207 displays information to the user, and receives an operation input from the user.

The network interface 208 connects to the LAN 103, and outputs and inputs information to and from PCs and other image processing apparatuses, which are connected to the same LAN. The above-mentioned devices are arranged on the system bus 210.

Further, the image processing apparatus 101 includes a scanner and a printer, and image input/output devices including the scanner and the printer are connected to the controller unit 201, but are omitted from illustration in FIG. 2.

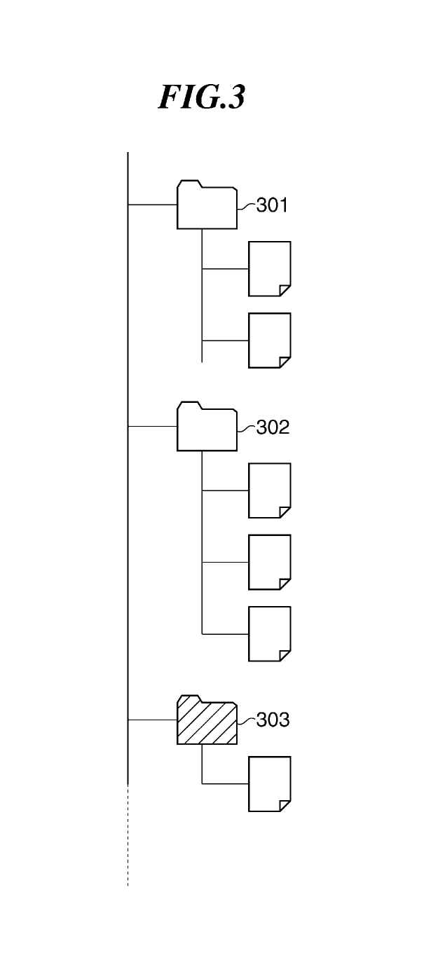

FIG. 3 is a diagram showing the structure of folders stored in the HDD 205 appearing in FIG. 2.

In FIG. 3, first, the folders created in the HDD 205 are classified into folders in a region where only the system of the image processing apparatus 101 can internally access and folders in a region which users can access.

Each user can store document files and the like, in the folders in the region which users can access, and can view, edit, delete, and output the stored document files.

FIG. 3 shows three folders, i.e. a folder 301, a folder 302, and an extension folder 303, which store two pieces of data, three pieces of data, and one piece of data, respectively. Note that the number of folders is not limited to three, and folders may have a layered structure. The extension folder 303 will be described hereinafter.

A method of storing data in a folder includes, for example, one in which an image is read using the scanner (not shown) of the image processing apparatus 101 and image data thus acquired is stored in the folder as a document file. Another one is that the PC 102 directly accesses a folder using a protocol, such as FTP (File Transfer Protocol), SMB (Service Message Block), or WebDAV (Distributed Authoring and Versioning protocol for the WWW), and then stores image data in the folder as a document file.

A user can view a folder and a stored document file by displaying them on the console section 207. If there are a plurality of folders and/or a plurality of document files, a list of the folders and/or a list of document files are/is displayed on the console section 207.

By selecting a desired document file from the list of the document files, the user can instruct various operations to be performed on the selected document file. The operations which can be instructed by the user include preview display, property display, page insertion, move/copy to another folder, document file deletion, and print.

Now, the extension folder 303 will be described. The extension folder 303 is a registration storage destination where a file for registering extensions of files is stored, i.e. a specific folder used for registering extensions of document files permitted to be stored. Note that as will be referred to hereinafter, there are other storage destinations (general folders) in the HDD 205 where files can be stored than the registration storage destination.

The extension folder 303 is configured as one of the folders existing in the region which users can access. However, the extension folder 303 is permitted to be accessed only by specific users, such as administrators who have administrative privileges. More specifically, only predetermined users out of users authorized to store files in the HDD 205 are permitted to store files in the extension folder 303.

Further, when storing a document file in the extension folder 303, processing for determining, according to an extension of the document file, whether or not a document file can be stored is not performed. In other words, no matter what extension the document file has, the document file can be stored.

Further, a folder can be created in the extension folder 303. This folder is used for associating a plurality of extensions with each other. For example, an administrator creates a new folder in the extension folder 303. Then, the administrator stores a document file in the created folder. The document file stored in this folder is treated as a file which can be stored in the HDD 205. Then, when the administrator opens the document file in the folder created in the extension folder 303 by using an application, a file having a different extension, such as an extension of a temporary file, is created. This file having the different extension, such as an extension of a temporary file, is created in the same folder that stores the document file by the application which has opened the document. In the present embodiment, the extension of the original document file and the extension of the temporary file are associated with each other for management, and both of the original document file and the temporary file are managed as files which can be stored in the HDD 205.

In the present embodiment, the extension of the original document file is referred to as a basic extension, and the extension associated with the original document file, such as an extension of a temporary file, is referred to as an associated extension.

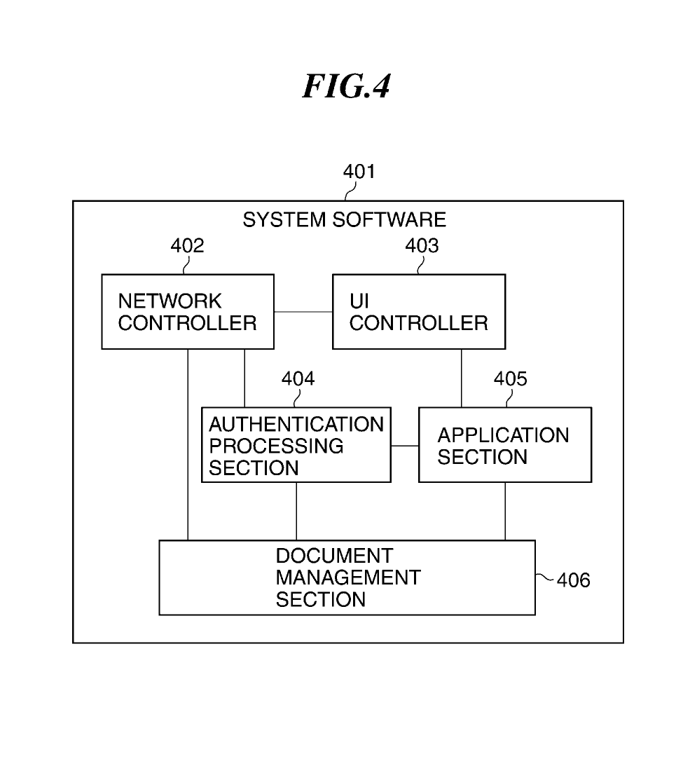

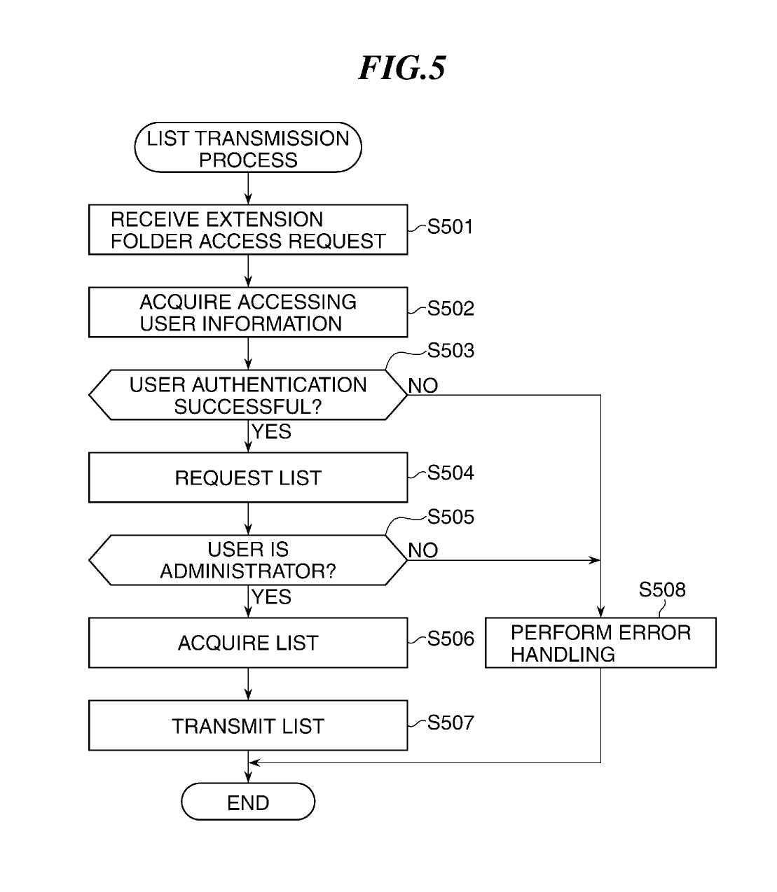

FIG. 4 is a diagram showing the software configuration of the image processing apparatus 101 appearing in FIG. 1.

System software 401 shown in FIG. 4 is executed by the CPU 202 by loading a program stored e.g. in the HDD 205 into the RAM 203.

A network controller 402 receives an instruction from the PC 102 connected to the LAN 103 via the network interface 208. Then, the network controller 402 requests one of a user interface controller 403, an authentication processing section 404, and a document management section 406, to perform processing according to the received instruction.

Further, the network controller 402 receives an instruction or a response from the user interface controller 403, the authentication processing section 404, and the document management section 406, and transmits the received instruction or response to the PC 102 connected to the LAN 103 via the network interface 208.

The user interface controller 403 receives information input by the user using the console section 207 via the console section interface 206, or receives an instruction from the network controller 402.

Then, the user interface controller 403 requests an application section 405 to perform processing according to the received information or instruction. Further, the user interface controller 403 receives a response from the application section 405, and displays the response on the console section 207 via the console section interface 206 or transmits the same to the network controller 402.

The authentication processing section 404 receives an authentication request from the network controller 402 or the application section 405, and transmits a response to the request. Further, the authentication processing section 404 receives an authentication acknowledgement request from the document management section 406, and transmits a response to the authentication acknowledgement request.

The user interface controller 403 also has a Web server function for interpreting and creating Web pages written in HTML (Hyper Text Markup Language) or the like. The network controller 402 receives Web pages by making use of HTTP (Hyper Text Transfer Protocol) or the like.

The user interface controller 403 interprets a Web page received by the network controller 402, creates a Web page for response, and transmits the created Web page for response, to the network controller 402.

The application section 405 receives an instruction from the user interface controller 403 and requests the authentication processing section 404 or the document management section 406 to perform processing according to the received instruction. Further, the application section 405 receives a response from the authentication processing section 404 or the document management section 406 and transmits the response to the user interface controller 403.

The document management section 406 receives a request for information on folders and document files from the network controller 402 or the application section 405. According to the request, the document management section 406 handles folders and document files which are stored in the HDD 205 or creates a new document file or a folder, and then transmits the results.

Further, the document management section 406 transmits an authentication acknowledgement request to the authentication processing section 404 and receives a response to the authentication acknowledgement request. The document management section 406 also performs processing for determining, according to an extension of the document file, whether or not a document file can be stored.

The document management section 406 stores a list of extensions of document files permitted to be stored in the RAM 203, and when a request for storing a document file whose extension does not exist in this list is received, the document management section 406 does not store the document file.

Further, the document management section 406 manages users' access rights to folders and document files which are stored. Further, the document management section 406 determines, according to a user having accessed a folder or document file, whether or not to permit the user to view or edit the folder or document file.

FIG. 5 is a flowchart of a list transmission process executed by the CPU 202 appearing in FIG. 2.

Referring to FIG. 5, first, the user sends an access request for access to the extension folder 303 by FTP, SMB, WebDAV, or the like protocol, using the PC 102. The network controller 402 receives the access request for access to the extension folder 303 (step S501) and acquires information on the accessing user from the information of the received access request (step S502).

The network controller 402 requests the authentication processing section 404 to authenticate the user as the sender of the access request for access to the extension folder 303. Then, the network controller 402 determines, based on a response from the authentication processing section 404, whether or not the user authentication is successful (step S503).

If it is determined in the step S503 that the user authentication is not successful (NO to the step S503), the network controller 402 performs error handling (step S508), followed by terminating the present process.

On the other hand, if it is determined in the step S503 that the user authentication is successful (YES to the step S503), the network controller 402 requests the document management section 406 to acquire a list stored in the extension folder 303 (step S504).

The document management section 406 queries the authentication processing section 404 as to whether or not the user requesting acquisition of the list is an administrator. Then, the document management section 406 determines, based on a response from the authentication processing section 404, whether or not the accessing user is an administrator (step S505).

If it is determined in the step S505 that the accessing user is not an administrator (NO to the step S505), the CPU 202 proceeds to the step S508.

On the other hand, if it is determined in the step S505 that the accessing user is an administrator (YES to the step S505), the network controller 402 acquires the list stored in the extension folder 303 from the document management section 406 (step S506), transmits the acquired list to the access request source via the network interface 208 (step S507), followed by terminating the present process.

The above-described process enables the administrator to access the extension folder 303, whereby the administrator can create and store a document file in the extension folder 303 from the PC.

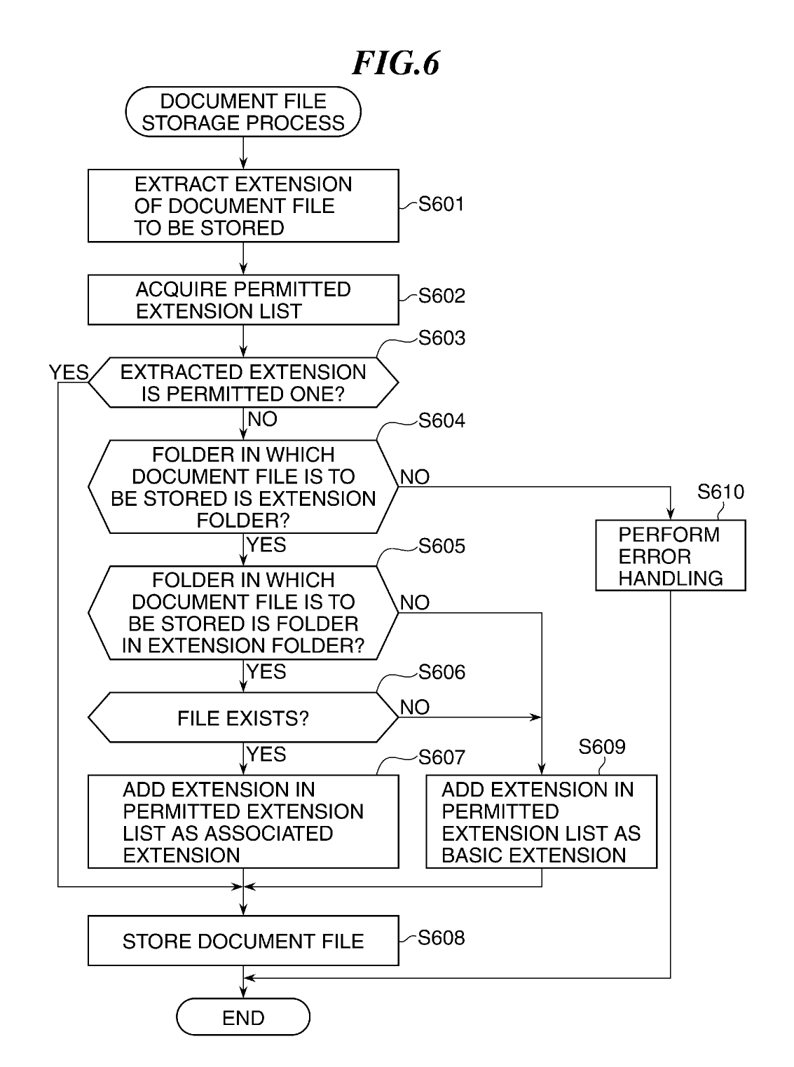

FIG. 6 is a flowchart of a document file storage process executed by the CPU 202 appearing in FIG. 2.

When the network controller 402 receives a request for storage (which may include creation) of a document file from the PC 102, and transmits the received storage request to the document management section 406, the document file storage process shown in FIG. 6 is executed by the document management section 406.

Upon receipt of the storage request from the PC 102, the document management section 406 extracts an extension of a document file to be stored (step S601), and acquires a permitted extension list stored in the RAM 203 or the HDD 205 (step S602). The permitted extension list will be described hereinafter.

Next, the document management section 406 determines, based on the permitted extension list acquired in the step S602, whether or not the extension extracted in the step S601 is a permitted extension (step S603).

If it is determined in the step S603 that the extracted extension is a permitted extension (YES to the step S603), the document management section 406 stores the document file (after creation thereof on an as-needed basis) in a designated folder (step S608), followed by terminating the present process.

On the other hand, if it is determined in the step S603 that the extracted extension is not a permitted extension (NO to the step S603), the document management section 406 determines whether or the document file is to be stored in the extension folder 303 (step S604).

If it is determined in the step S604 that it is not in the extension folder 303 that the document file is to be stored (NO to the step S604), this means that the document file cannot be stored, and hence the document management section 406 performs error handling (step S610), followed by terminating the present process.

On the other hand, if it is determined in the step S604 that the document file is to be stored in the extension folder 303 (YES to the step S604), the document management section 406 determines whether or not the document file is to be stored in a folder in the extension folder 303 (step S605).

If it is determined in the step S605 that it is not in a folder in the extension folder 303 that the document file is to be stored (NO to the step S605), the document management section 406 adds the extracted extension to the permitted extension list as a basic extension (step S609), and then the CPU 202 proceeds to the step S608.

On the other hand, if it is determined in the step S605 that the document file is to be stored is a folder in the extension folder 303 (YES to the step S605), the document management section 406 determines whether or not a document file already exists in the folder in the extension folder 303 (step S606).

If it is determined in the step S606 that no document file already exists in the folder in the extension folder 303 (NO to the step S606), the document management section 406 adds the extracted extension to the permitted extension list as a basic extension (step S609), and then the CPU 202 proceeds to the step S608.

On the other hand, if it is determined in the step S606 that a document file already exists in the folder (YES to the step S606), it is determined that the file is a temporary file of the existing document file, so that the document management section 406 adds the extracted extension to the permitted extension list as an associated extension of the existing document file (step S607), and then the CPU 202 proceeds to the step S608. Thus, it is made possible to add a basic extension and an associated extension to the permitted extension list, and store a temporary file generated by opening a file identified by the basic extension in the HDD 205.

According to the document file storage process, the administrator can store even a document file with an unpermitted extension given thereto to be stored in the extension holder 303. At this time, the extension of the document file is stored in the permitted extension list.

Further, in a case where the administrator has stored a document file in a folder in the extension folder 303, the extension of the document file is stored in the permitted extension list as a basic extension.

Then, an extension of a temporary file created e.g. by editing the document file stored in the folder in the extension folder 303 is stored as an associated extension in association with the basic extension.

In the above-described document file storage process, a registration storage destination for use in registering a basic extension corresponds to the extension folder 303 or a folder in the extension folder 303, and a registration storage destination for use in registering an associated extension corresponds to the folder in the extension folder 303. It is possible to provide a plurality of folders within the extension folder 303. This makes it possible to associate a file in one of the folders with a temporary file, and thereby manage association between a basic extension of each file and an associated extension of a temporary file associated therewith.

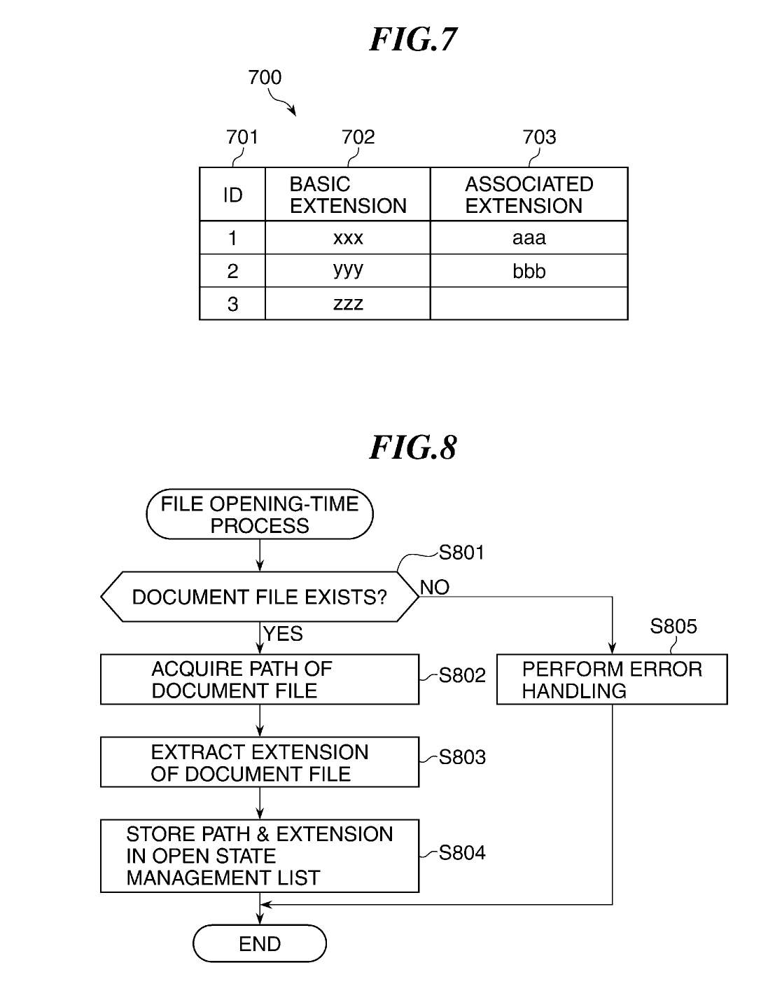

FIG. 7 is a diagram showing an example of the permitted extension list, denoted by reference numeral 700, stored in the RAM 203 appearing in FIG. 2.

Referring to FIG. 7, the permitted extension list (permitted list) 700 indicates extensions of document files permitted to be stored in the HDD 205, and is composed of IDs 701 for identifying permitted extensions, respectively, basic extensions 702, and associated extensions 703 which are associated with the basic extensions, respectively.

In the illustrated example, “xxx”, “yyy”, and “zzz” are stored as basic extensions. Further, associated extensions “aaa” and “bbb” are stored in association with the basic extensions “xxx” and “yyy”, respectively.

Some basic extension each have a plurality of associated extensions, and some other basic extensions each have no associated extension.

As shown in FIGS. 6 and 7, the step S609 in FIG. 6 corresponds to an operation of a management unit performed, in a case where no file exists in a registration storage destination in which a file is to be stored, for registering an extension of the stored file in the permitted list indicating extensions of files which can be stored in the HDD 205, as a basic extension.

Further, the step S607 in FIG. 6 corresponds to an operation of the management unit performed, in a case where a new file is created in a registration storage destination in which a file having an extension registered as a basic extension is stored, for storing an extension of the new file in the permitted list, as an associated extension which is an extension associated with a basic extension, in association with the basic extension.

FIG. 8 is a flowchart of a file opening-time process executed by the CPU 202 appearing in FIG. 2.

The file opening-time process shown in FIG. 8 is executed when a document file stored in a general folder (folder other than the extension folder in the HDD 205) is opened. When a user designates a document file stored in the general folder from the PC 102 to open the same, using a protocol, such as FTP, SMB, or WebDAV, the network controller 402 receives a document file opening request.

Then, when the network controller 402 requests the document management section 406 to open the designated document file, the document management section 406 executes the present process.

The document management section 406 determines whether or not the designated document file exists (step S801). If it is determined in the step S801 that the designated document file does not exist (NO to the step S801), the document management section 406 performs error handling (step S805), followed by terminating the present process.

On the other hand, if it is determined in the step S801 that the designated document file exists (YES to the step S801), the document management section 406 acquires a path of the document file requested to be opened (step S802), and further, extracts the extension of the document file (step S803).

Then, the document management section 406 adds the acquired path information and extension to an open state management list (step S804), followed by terminating the present process.

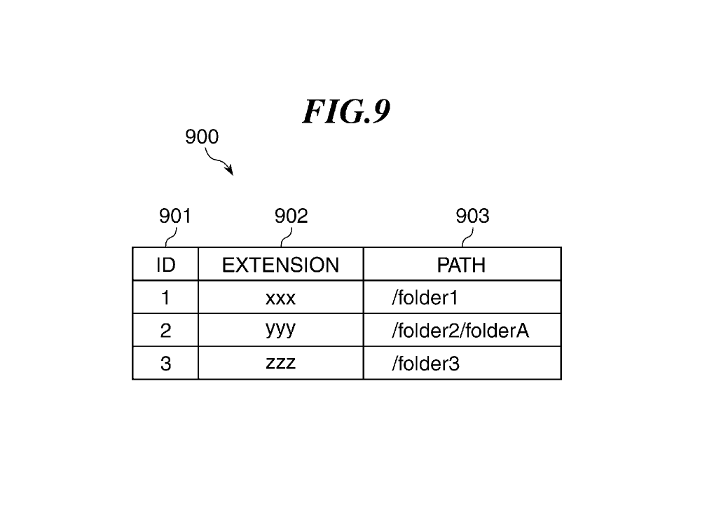

FIG. 9 is a diagram showing an example of the open state management list, denoted by reference numeral 900, stored in the RAM 203 appearing in FIG. 2.

In FIG. 9, the open state management list 900 is composed of IDs 901 for identifying management information items of respective document files in an open state, extensions 902 of the respective document files in the open state, and paths 903 in which the respective document files exist.

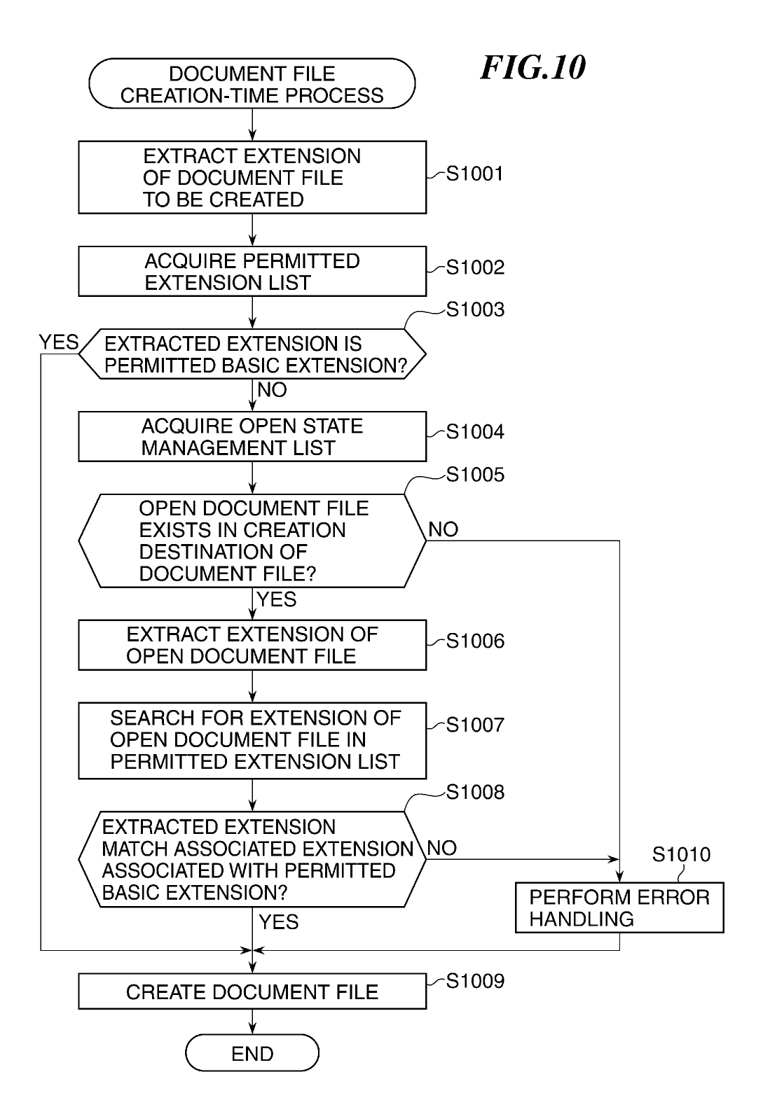

FIG. 10 is a flowchart of a document file creation-time process executed by the CPU 202 appearing in FIG. 2.

The process shown in FIG. 10 is executed when creating a document file in the general folder, and is executed by the document management section 406 when the network controller 402 receives a document file creation request from the PC 102 and transmits the received document file creation request to the document management section 406.

The document management section 406 extracts the extension of the document file to be created (step S1001), and acquires the permitted extension list stored in the RAM 203 (step S1002).

Then, the document management section 406 determines whether or not the extension extracted in the step S1001 is a basic extension registered in the permitted extension list 700 (step S1003). If it is determined in the step S1003 that the extracted extension is a registered i.e. permitted basic extension (YES to the step S1003), the document management section 406 creates the document file in the designated folder (step S1009), followed by terminating the present process.

On the other hand, if it is determined in the step S1003 that the extracted extension is not a registered i.e. permitted basic extension (NO to the step S1003), the document management section 406 acquires the open state management list stored in the RAM 203 (step S1004).

In the step S1003, even if the extracted extension is not a permitted basic extension registered in the permitted extension list 700, the document file can be a temporary file which is created when a document file having a registered i.e. permitted basic extension is opened.

Therefore, in the step S1004, the document management section 406 acquires the open state management list in order to determine whether or not a document file in the open state exists in the destination in which the document file is to be created.

Then, the document management section 406 determines whether or not a document file in the open state exists in the destination in which the document file is to be created (step S1005). If it is determined in the step S1005 that no document file in the open state exists (NO to the step S1005), the document management section 406 performs error handling (step S1010), followed by terminating the present process. This is because the document file to be created is not a temporary file or the like of the document file in the open state.

On the other hand, if it is determined in the step S1005 that a document file in the open state exists in the destination in which the document file is to be created (YES to the step S1005), the document management section 406 acquires the extension of the document file in the open state (step S1006), and searches the basic extensions in the permitted extension list for the acquired extension (step S1007). By this search, a permitted extension matching the basic extension of the document file in the open state is searched for.

Then, the document management section 406 determines whether or not the extension extracted in the step S1001 matches an associated extension associated with the permitted basic extension of the document file in the open state (step S1008). If it is determined in the step S1008 that the extracted extension matches an associated extension associated with the permitted basic extension (YES to the step S1008), the document management section 406 creates the document file requested to be created (step S1009), followed by terminating the present process. This is because it can be judged that the document file to be created is a document file associated with the document file in the open state (e.g. a temporary file which is created when the document file is opened).

On the other hand, if it is determined in the step S1008 that the extracted extension does not match an associated extension associated with the permitted basic extension (NO to the step S1008), the process proceeds to the step S1010. The step S1008 corresponds to the operation of a permission unit configured to permit a file associated with a file of which a type is indicated by a basic type information item managed by the management unit and which is open to be stored in the storage section.

According to this process, when storing document files in the image processing apparatus 101, storage of document files each having a basic extension registered in the permitted extension list is permitted.

Further, when handling a stored document file by using a document editing application which creates a temporary file, it is possible to permit the temporary file to be created only when the document file is opened.

According to the above-described present embodiment, first, when no file exists in a registration storage destination (folder in the extension folder 303) for use in registering an extension of a file, a file is stored in the registration storage destination, and the extension of the stored file is registered as a basic extension in the permitted extension list indicating extensions of files which are permitted to be stored in the HDD 205.

Then, when creating a new file in the registration storage destination in which the file having the extension registered as the basic extension is stored, the extension of the new file is registered in association with the basic extension as an associated extension which is an extension associated with the basic extension.

Then, a file presumed to be associated with (to have an associated extension of) a file which has a registered basic extension and is open is permitted to be stored in a storage destination which is provided in the HDD 205 and is other than a predetermined storage destination (extension folder 303) including a registration storage destination (folder in the extension folder 303). Therefore, it is possible to provide the image processing apparatus 101 which is capable of easily setting files permitted to be stored and enables editing of the stored files.

Further, according to the present embodiment, it is possible to prevent storage of malicious files, while properly enabling operations for storage and editing of document files.

Further, although in the present embodiment, the open state management list is stored, whereby a file associated with a document file being open is permitted to be created, this is not limitative, but creation of a file may be permitted insofar as a file exists in the same folder where the created file is to stored without limiting the condition such that a file in the same folder is open. Further, although in the present embodiment, a type of a file to be permitted to be stored is identified using an extension of the file, this is not limitative, but information other than the extension, such as content-type, file type code, or creator code, may be used insofar as it enables identification of the type of the file.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-225019, filed Oct. 10, 2012, which is hereby incorporated by reference herein in its entirety.

What is claimed is:

1. An image processing apparatus comprising:
a storage section configured to be capable of storing files;
a management unit configured to manage basic type information items each indicative of a type of a file permitted to be stored in said storage section and associated type information items each indicative of a type of a file associated with a file permitted to be stored in said storage section, in association with each other; and
a permission unit configured to permit a file associated with a file of which a type is indicated by a basic type information item managed by said management unit and which is open to be stored in said storage section.

2. The image processing apparatus according to claim 1, wherein said permission unit is configured to permit the file associated with the file which is open to be stored in the same folder that stores the file which is open.

3. The image processing apparatus according to claim 1, wherein said management unit is configured to register an information item indicative of a type of a file which is stored in a predetermined folder in said storage section, as a basic type information item.

4. The image processing apparatus according to claim 3, wherein said management unit is configured to register, when a new file is created in the predetermined folder by opening a file stored in the predetermined folder, an information item indicative of a type of the created file, as the type of a file associated with a file permitted to be stored in said storage section.

5. The image processing apparatus according to claim 3, wherein access to said predetermined folder is permitted to a predetermined user of the image processing apparatus.

6. The image processing apparatus according to claim 1, wherein the basic type information item is an extension of a file permitted to be stored in said storage section.

7. The image processing apparatus according to claim 1, wherein the associated type information is an extension associated with a file permitted to be stored in said storage section.

8. The image processing apparatus according to claim 1, wherein the type of a file associated with a file permitted to be stored in said storage section is a temporary file created by a predetermined application which has opened the file permitted to be stored in said storage section.

9. A method of controlling an image processing apparatus including a storage section configured to be capable of storing files, comprising:
managing basic type information items each indicative of a type of a file permitted to be stored in the storage section and associated type information items each indicative of a type of a file associated with a file permitted to be stored in the storage section, in association with each other; and
permitting a file associated with a file of which a type is indicated by a basic type information item managed by said managing and which is open to be stored in the storage section.

10. A non-transitory computer-readable storage medium storing a computer-executable program for causing a computer to execute a method of controlling an image processing apparatus including a storage section configured to be capable of storing files,
wherein the method comprises:
managing basic type information items each indicative of a type of a file permitted to be stored in the storage section and associated type information items each indicative of a type of a file associated with a file permitted to be stored in the storage section, in association with each other; and
permitting a file associated with a file of which a type is indicated by a basic type information item managed by said managing and which is open to be stored in the storage section.
